(19) United States
(12) Patent Application Publication
(10) Pub. No.: US 2024/0425744 A1
(43) Pub. Date: Dec. 26, 2024

(54) PREVENTING WATER PRODUCTION IN SUBTERRANEAN FORMATIONS

(71) Applicant: Saudi Arabian Oil Company, Dhahran (SA)

(72) Inventors: Rajendra Arunkumar Kalgaonkar, Dhahran (SA); Vikrant Wagle, Dhahran (SA); Qasim Sahu, Al Muntazah (SA)

(21) Appl. No.: 18/341,451

(22) Filed: Jun. 26, 2023

(51) Int. Cl. C09K 8/506; C09K 8/504; E21B 33/138

(52) U.S. Cl. CPC C09K 8/506; C09K 8/5045; E21B 33/138; C09K 2208/10

(57) ABSTRACT

A method and system for controlling unwanted water production from a water-producing zone in a subterranean formation are provided. An exemplary method includes flowing an alkaline suspension of nanosilica particles into a wellbore such that it contacts the water-producing zone, and flowing a formate salt solution into the wellbore such that it contacts the alkaline suspension in the water-producing zone producing a composition. The wellbore is shut in a duration of time sufficient for the composition to form a gel that is impermeable to fluid flow.

### TECHNICAL FIELD

The present disclosure is directed to compositions for limiting co-produced water with gels formed using nanosilica particles.

### BACKGROUND

The production of crude oil and other hydrocarbons starts with the drilling of a wellbore into a hydrocarbon reservoir. In many cases, the hydrocarbon reservoir is a narrow layer of material in the subterranean environment, wherein other layers have high water content. Further, as a well is produced, previously productive layers may start producing higher amounts of water.

Excessive water production greatly affects the economic life of producing wells. High water cut largely affects the economic life of producing wells and is also responsible for many damage mechanisms related to oilfield equipment such as scale deposition, fines migration, asphaltene precipitation, and corrosion. This also leads to increased operating costs to separate, treat, and dispose of the produced water according to environmental regulations. Though a variety of chemicals are used by the industry to control water production, most of them are not accepted in regions that have strict environmental regulations.

### SUMMARY

An embodiment described herein provides a method for controlling unwanted water production from a water-producing zone in a subterranean formation. The method includes flowing an alkaline suspension of nanosilica particles into a wellbore such that it contacts the water-producing zone, and flowing a formate salt solution into the wellbore such that it contacts the alkaline suspension in the water-producing zone producing a composition. The wellbore is shut in a duration of time sufficient for the composition to form a gel that is impermeable to fluid flow.

Another embodiment described herein provides a water shutoff material for a wellbore. The water shutoff material includes a gel formed from an alkaline suspension of nanosilica particles and a formate salt solution.

### BRIEF DESCRIPTION OF DRAWINGS

FIG. 1 is a schematic drawing of a wellbore, showing increased production of water in a reservoir layer in a subterranean formation.

FIG. 2 is a schematic drawing of a method of sealing a section of a wellbore to decrease coproduction of water 104 using an alkaline suspension of nanosilica particles.

FIG. 3 is a process flow diagram of a method for shutting off water from a zone in a well.

FIG. 4 is an image of a silica gel formed from an alkaline suspension of nanosilica particles and sodium formate.

FIG. 5 is a close up image of a silica gel formed from an alkaline suspension of nanosilica particles and sodium formate.

### DETAILED DESCRIPTION

Compositions are provided herein for preventing unwanted water production by shutting off water-producing zones. The compositions are based on an activation chemistry to form a gel from alkaline suspensions of nanosilica particles. The nanosilica particles are generally considered environmentally benign and the chemicals disclosed herein for treatment and activation also do not cause environmental issues.

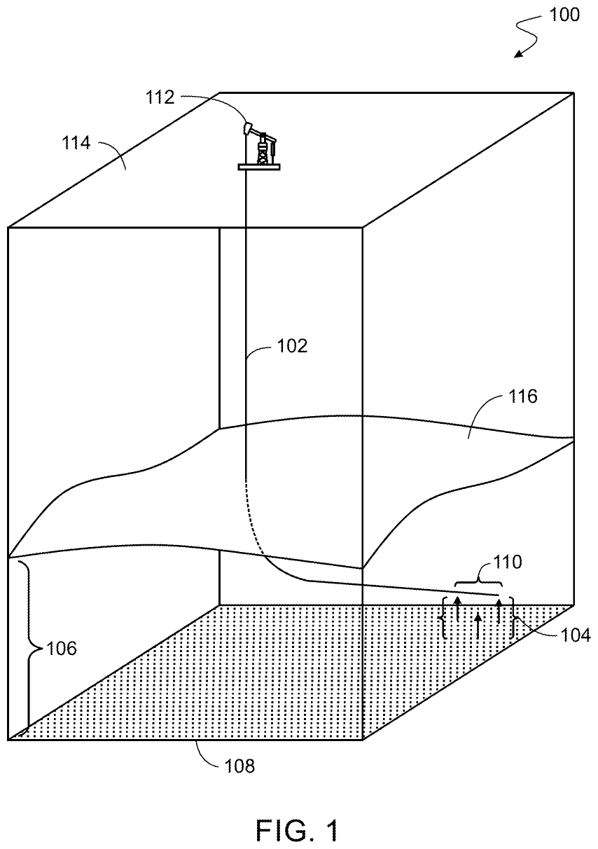

FIG. 1 is a schematic drawing 100 of a wellbore 102, showing increased production of water 104 in a reservoir layer 106 in a subterranean formation. The water 104 may come from an underlying water table, or water layer 108, below the reservoir layer 106. A section 110 of the wellbore 102 closest to the water layer 108 may draw water 104 into the wellbore 102 during the pumping cycle of a pump jack 112 at the surface 114, increasing the amount of produced water.

In other circumstances, a continuous production from the reservoir layer 106 to the surface 114 may entrain water 104 from the water layer 108, increasing the amount of water 104 produced from the section 110 of the wellbore. Further, as the reservoir layer 106 is produced, the amount of hydrocarbons between the water layer 108 and a cap rock layer 116 decreases, which may allow the water layer 108 to draw closer to the cap rock layer 116, moving closer to the section 110 of the wellbore 102. This may also increase the amount of water 104 produced.

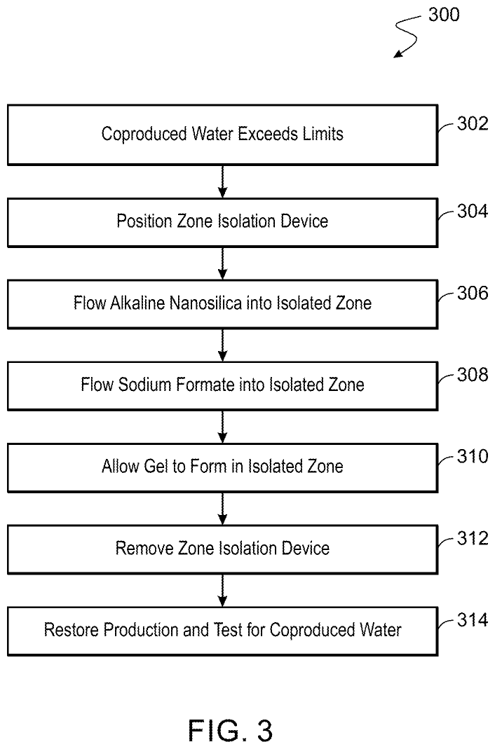

In various embodiments described herein, nanosilica particles may be used to form a gel, blocking production from the section 110 of the wellbore 102. As described further with respect to FIG. 3, in various embodiments, an alkaline suspension of the nanosilica particles is injected into the wellbore 102 to the section 110 to be shut off. The alkaline suspension of the nanosilica particles may be pushed into the section 110, for example, through the perforations in the production tubing at that point. The activator, sodium formate, may then be injected into the wellbore 102, causing the gelation of the nanosilica particles.

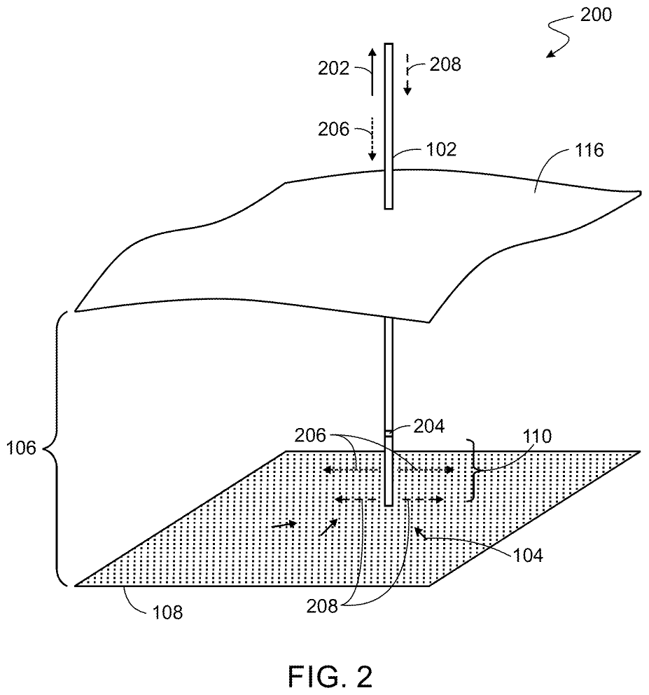

FIG. 2 is a schematic drawing of a method 200 of sealing a section 110 of a wellbore 102 to decrease coproduction of water 104 using an alkaline suspension of nanosilica particles. Like numbered items are as described with respect to FIG. 1. In the example shown in FIG. 2, the wellbore 102 is shown as vertical. However, as shown in the example of FIG. 1, the wellbore can be directionally drilled into the reservoir layer 106.

The method 200 begins when the produced fluids 202 include an unacceptable amount of water 104, for example, coproduced from a water layer 108. The section 110 of the wellbore 102 closest to the water layer 108 may be responsible for the majority of the water 104 that is coproduced. Accordingly, sealing off this section 110 will lower the amount of water 104 in the produced fluids 202.

To begin, a zonal isolation tool, such as a packer 204, may be placed in the wellbore 102 to isolate the section 110 responsible for the majority of the production of the water 104. Once the packer 204 is in place, an alkaline suspension 206 of nanosilica particles is injected into the wellbore 102, for example, through a coil tubing line to the section 110 that is being sealed off. The alkaline suspension 206 of the nanosilica particles may be forced through the section 110 of the wellbore 102 and into the portion of the reservoir layer 106 surrounding the section 110.

After the alkaline suspension 206 is injected into the wellbore 102, sodium formate 208 is injected through the wellbore 102 and into the section 110 as an activator. The sodium formate 208 initiates the gelling of the alkaline nanosilica particles in the perforations of the section 110 and in the associated region of the reservoir layer 106. The formation of the gel may then seal the section 110 of the wellbore 102 and the associated region of the reservoir layer 106, decreasing or eliminating the coproduction of water 104.

Once the gelation is completed, the packer 204 may be removed from the wellbore 102. Production is restarted and the amount of water in the produced fluids 202 is determined to ensure that the sealing of the section 110 was successful.

The use of the gel for shutting off regions that are producing water allows for a simpler solution than leaving packers or other zonal isolation devices in the well for long periods of time. Further, sealing of the reservoir layer 106 associated with the section 110 of the wellbore 102 allows for continuing production of lower zones without placing restrictions due to zonal isolation devices in the wellbore 102.

FIG. 3 is a process flow diagram of a method 300 for shutting off water from a zone in a well. The method 300 begins at block 302 with a determination that the coproduced water has exceeded acceptable limits. For example, the coproduced water may be greater than about 1 vol. % of the produced fluids, greater than about 5 vol. %, or greater than about 25 vol. %. A determination is made as to the location, or source, of the produced water in the wellbore. This may be performed using a coil tubing in an underbalanced condition to measure the water at different locations in the wellbore to identify the section of the wellbore to be sealed.

Once the source of the produced water is identified, at block 304, a zone isolation device is placed to isolate the zone from other portions of the wellbore. The zone isolation device may be a packer, or other zonal isolation system, that is placed in the production tubing, outside the production tubing in the wellbore, or both. If the layer that is the source of the produced water is in an intermediate position in the wellbore, for example, lying both above and below productive zones, multiple zonal isolation devices may be used to isolate that portion of the wellbore for sealing.

Once the zonal isolation device is in place, at block 306 an alkaline suspension of nanosilica particles may be pumped into the isolated zone. This may be performed at sufficient pressure to push the alkaline suspension of nanosilica particles into the portion of the reservoir layer that is producing water.

In some embodiments, the alkaline suspension of nanosilica particles includes an anionic alkaline colloidal silica, for example, wherein the surface of the nanosilica particles is unmodified, leaving oxygen ions at the surface. In some embodiments, the surface of the nanosilica particles is modified to have an anionic or alkaline surface group. The anionic surface may be stabilized using a cationic counterion, such as lithium, sodium, or potassium among others. The alkaline suspension may be formed by dissolving the hydroxide salt of the cationic counterion in the solution, for example, in the form of lithium hydroxide, sodium hydroxide, or potassium hydroxide.

In some embodiments, the nanosilica particles in the alkaline suspension have an average particle diameter ranging from about 2 to about 150 nm, such as from about 3 to about 50 nm, or from about 5 to about 25 nm. In some embodiments, the average particle diameter is in the range of from about 6 to about 20 nm. In some embodiments, the nanosilica particles have a specific surface area from about 20 to about 1500 m² g⁻¹, such as from about 50 to about 900 m² g⁻¹, from about 70 to about 600 m² g⁻¹, or from about 70 to about 400 m² g⁻¹, or about 160 m² g⁻¹.

In some embodiments, the alkaline suspension of the nanosilica particles may be between about 10 wt. % and about 50 wt. % silica (SiO₂), or between about 15 wt. % and about 35 wt. % silica, or about 25 wt. % silica. In some embodiments, the alkaline suspension of nanosilica particles is between about 5 wt. % and about 50 wt. % solids, between about 20 wt. % and about 40 wt. % solids, or about 31 wt. % solids. In some embodiments, the pH of the alkaline suspension is between about 8 and about 14, or between about 9 and about 11, or about 10. In some embodiments, the viscosity of the alkaline suspension, in centipoise (cP), is between about 1 and about 6, or between about 2 and about 5, or about 3 cP. In some embodiments, the density of the alkaline suspension may be between about 1.1 g cm⁻³ and about 1.5 g cm⁻³, or about 1.32 g cm⁻³.

In some embodiments, the alkaline suspension of nanosilica particles is a commercially available product, for example, from the Idisil® product line, available from the Evonik industries AG, Essen, Germany.

At block 308, a formate salt, such as sodium formate, solution is pumped into the isolated zone as an activator. The formate salt triggers the gelation of the nanosilica particles in the alkaline suspension, forming an impermeable gel that seals the portion of the reservoir. Formate salt solutions are alkaline, for example, with a sodium formate salt solution having a pH of about 9 at a concentration of 0.24 molar. Generally, it is believed that the formate may prevent the counterions of the nanoparticle dispersion from forming a charge-neutral layer around the silica nanoparticles, which allows the dispersion to coalesce and form a silica gel.

In some embodiments, the amount of formate salt used is between about 5% and about 50%, by weight, of the alkaline suspension of nanosilica particles. In some embodiments, the amount of formate salt used is between about 15% and about 35%, by weight, of the alkaline suspension of nanosilica particles. In some embodiments, the amount of formate salt used is about 25%, by weight, of the alkaline suspension of nanosilica particles.

In some embodiments, the activator is a formic acid salt, or formate salt, that includes a cationic counterion. The counterion can be an alkaline metal, such as lithium, sodium, or potassium. The cation is selected from alkaline metals, ammonium ions, including primary ammonium, secondary ammonium, tertiary ammonium, and quaternary ammonium ions, and organic cations such as amino and organoamino ions.

In some embodiments, the pumping of the alkaline suspension of nanosilica particles is alternated with the pumping of the formate salt solution, allowing the formation of layers of gel deeper in the rock of the reservoir.

At block 310, the gel is allowed to form in the isolated zone. This may be performed by shutting in the well for a sufficient period of time to allow the gel to form before proceeding to further steps. The gelation may be complete in about one hour, about two hours, about five hours, about 10 hours, about 15 hours, or about 20 hours. The gelation time, and the properties of the final gel, may be controlled by the ratio of the nanosilica particles to the activator and the temperature of the reservoir. The gelation temperature may be about 50° C., 100° C., 120° C., 150° C., or higher. Higher temperatures will shorten gelation time.

At block 312, the zonal isolation device is removed. If multiple zonal isolation devices were used, for example, at the top and bottom of a layer contributing to coproduced water, they both may be removed to allow production from lower levels in the reservoir.

At block 314, production is restored and the produced fluids are tested for coproduced water. If the amount of coproduced water is still too high, the procedure may be needed for other zones in the reservoir.

### EXAMPLES

### Materials

Sodium formate was purchased from Sigma-Aldrich and used as purchased.

The alkaline nanosilica dispersion was obtained from Evonik, as grade IDISIL SI 4545. The typical properties of the alkaline nanosilica dispersion is given in Table 1.

TABLE 1
Properties of alkaline nanosilica dispersion.

| | | | | | |
|---|---|---|---|---|---|
| | | | Specific | Viscosity | |
| Particle size- | | pH@ | gravity | @ 25° C. | Visual |
| Titrated (nm) | % SiO2 | 25° C. | (g/ml) | (cps) | appearance |

| | | | | |
|---|---|---|---|---|
| 45 | 45 | 9-11 | 1.32 | white/off- |
| | | | | white |

### Synthesis of Test Gel

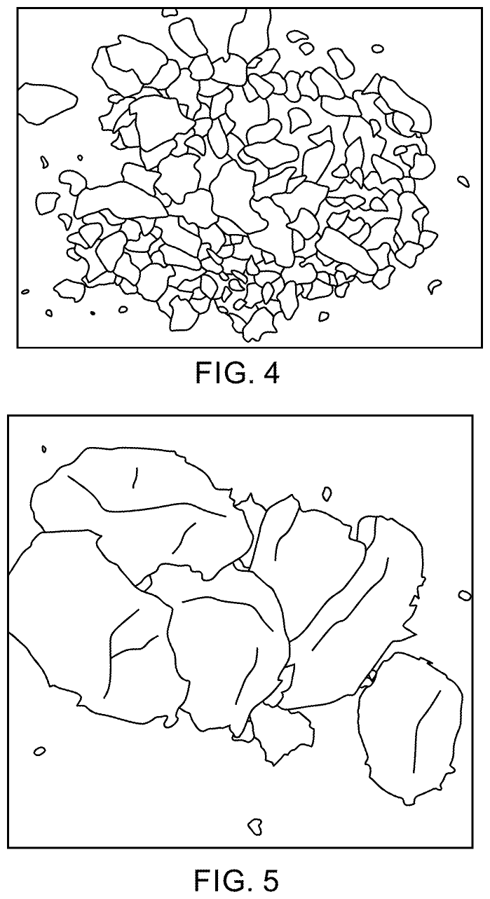

To synthesize a test gel, 80 g of alkaline nanosilica dispersion was placed in a beaker. 20 gms of sodium formate was added to the 80 g of alkaline nanosilica dispersion in the beaker. The dispersion was mixed well using a stirrer. The nanosilica dispersion along with sodium formate was subjected to static aging at 250° F. (121.1° C.) for 16 hours. After 16 hours of static aging, the nanosilica dispersion was converted into a solid as shown in FIGS. 4 and 5.

FIG. 4 is an image of a silica gel formed from an alkaline suspension of nanosilica particles and sodium formate. FIG. 5 is a close up image of the silica gel formed from an alkaline suspension of nanosilica particles and sodium formate.

### EMBODIMENTS

An embodiment described herein provides a method for controlling unwanted water production from a water-producing zone in a subterranean formation. The method includes flowing an alkaline suspension of nanosilica particles into a wellbore such that it contacts the water-producing zone, and flowing a formate salt solution into the wellbore such that it contacts the alkaline suspension in the water-producing zone producing a composition. The wellbore is shut in a duration of time sufficient for the composition to form a gel that is impermeable to fluid flow.

In an aspect, combinable with any other aspect, the formate salt solution includes sodium formate.

In an aspect, combinable with any other aspect, the formate salt solution includes lithium formate, potassium formate, or ammonium formate, or any combination thereof.

In an aspect, combinable with any other aspect, the method includes determining that coproduced water exceeds acceptable limits.

In an aspect, combinable with any other aspect, the method includes placing a zonal isolation device above the water-producing zone prior to flowing the alkaline suspension of nanosilica particles into the wellbore.

In an aspect, combinable with any other aspect, the method includes placing a zonal isolation device below the water-producing zone prior to flowing the alkaline suspension of nanosilica particles into the wellbore.

In an aspect, combinable with any other aspect, the method includes pumping the alkaline suspension of the nanosilica particles into the water-producing zone.

In an aspect, combinable with any other aspect, the method includes pumping a solution of the formate salt solution into the water-producing zone after the alkaline suspension of the nanosilica particles.

In an aspect, combinable with any other aspect, the method includes alternating flowing the alkaline suspension of the nanosilica particles into the water-producing, and flowing the formate salt solution into the water-producing zone after the alkaline suspension of the nanosilica particles.

In an aspect, combinable with any other aspect, the method includes shutting in the wellbore for about 16 hours at 121° C.

In an aspect, combinable with any other aspect, the method includes removing a zonal isolation device from above the water-producing zone after the formation of the gel.

In an aspect, combinable with any other aspect, the method includes removing a zonal isolation device from below the water-producing zone after the formation of the gel.

Another embodiment described herein provides a water shutoff material for a wellbore. The water shutoff material includes a gel formed from an alkaline suspension of nanosilica particles and a formate salt solution.

In an aspect, combinable with any other aspect, the formate salt solution includes sodium formate.

In an aspect, combinable with any other aspect, the formate salt solution includes lithium formate or potassium formate or both.

In an aspect, combinable with any other aspect, the formate salt solution includes ammonium formate.

Other implementations are also within the scope of the following claims.

What is claimed is:

1. A method for controlling unwanted water production from a water-producing zone in a subterranean formation, comprising:
flowing an alkaline suspension of nanosilica particles into a wellbore such that it contacts the water-producing zone;
flowing a formate salt solution into the wellbore such that it contacts the alkaline suspension in the water-producing zone producing a composition; and
shutting in the wellbore for a duration of time sufficient for the composition to form a gel that is impermeable to fluid flow.

2. The method of claim 1, wherein the formate salt solution comprises sodium formate.

3. The method of claim 1, wherein the formate salt solution comprises lithium formate, potassium formate, or ammonium formate, or any combination thereof.

4. The method of claim 1, comprising determining that coproduced water exceeds acceptable limits.

5. The method of claim 1, comprising placing a zonal isolation device above the water-producing zone prior to flowing the alkaline suspension of nanosilica particles into the wellbore.

6. The method of claim 1, comprising placing a zonal isolation device below the water-producing zone prior to flowing the alkaline suspension of nanosilica particles into the wellbore.

7. The method of claim 1, comprising pumping the alkaline suspension of the nanosilica particles into the water-producing zone.

8. The method of claim 1, comprising pumping a solution of the formate salt solution into the water-producing zone after the alkaline suspension of the nanosilica particles.

9. The method of claim 1, comprising alternating:
flowing the alkaline suspension of the nanosilica particles into the water-producing; and
flowing the formate salt solution into the water-producing zone after the alkaline suspension of the nanosilica particles.

10. The method of claim 1, comprising shutting in the wellbore for about 16 hours at 121° C.

11. The method of claim 1, comprising removing a zonal isolation device from above the water-producing zone after the formation of the gel.

12. The method of claim 1, comprising removing a zonal isolation device from below the water-producing zone after the formation of the gel.

13. A water shutoff material for a wellbore, comprising a gel formed from:
an alkaline suspension of nanosilica particles; and
a formate salt solution.

14. The water shutoff material of claim 13, wherein the formate salt solution comprises sodium formate.

15. The water shutoff material of claim 13, wherein the formate salt solution comprises lithium formate or potassium formate or both.

16. The water shutoff material of claim 13 wherein the formate salt solution comprises ammonium formate.
